(19) United States
(12) Patent Application Publication
(10) Pub. No.: US 2009/0119603 A1
(43) Pub. Date: May 7, 2009

(54) Interaction Scheduling Based On Activity Status Updates

(76) Inventor: David Scott Stackpole, Charlottesville, VA (US)

Correspondence Address: Ashok Tankha, 36 Greenleigh Drive, Sewell, NJ, 08080, US

(21) Appl. No.: 12/265,730

(22) Filed: Nov. 5, 2008

Related U.S. Application Data
(60) Provisional application No. 61/001,914, filed on Nov. 5, 2007.

(51) Int. Cl. G06F 3/00; G06F 17/30; G06F 7/06

(52) U.S. Cl. 715/753; 707/102; 707/3; 707/E17.014; 707/E17.044

(57) ABSTRACT

Disclosed herein is a computer implemented method and system of scheduling interactions between a first user and one or more of multiple second users in an electronic environment based on activity information of the second users. The second users provide information on multiple activities of the second users in the electronic environment. Current activity status and the future activity status of the second users are determined from the activity information. The first user is updated on the determined current activity status and the determined future activity status of the second users. The computer implemented method and system disclosed herein enables the first user to plan the interactions with the second users based on the current activity status and the future activity status of the second users. The planning enables the scheduling of the interactions with the second users.

### CROSS REFERENCE TO RELATED APPLICATIONS

This application claims the benefit of provisional patent application No. 61/001,914 titled “Method for Dynamically Sending and Receiving Activities Updates”, filed on Nov. 5, 2007 in the United States Patent and Trademark Office.

### BACKGROUND

This invention, in general, relates to online activity planning. More particularly, this invention relates to scheduling interactions between a first user and one or more second users in an electronic environment based on activity information of the second users.

People typically enjoy interacting with friends and acquaintances. People also look towards close friends for advice and approval. Also, people tend to associate more and become close to persons where a face to face interaction occurs. The interactions may, for example, be at coffee shops, restaurants, etc. However, due to the conflicting or busy schedule of persons, planning and scheduling face to face interactions with friends is difficult. Also, people may not know about activities that their friends are engaged in and therefore may be unable to participate in such activities due to lack of knowledge of the activities. Also, contacting every friend to find out about their activities or to schedule new activities may be cumbersome. Group calendars may be used to view scheduled activities of a group of people. However, existing group calendars provide only basic scheduling functionality and lack many details and functions.

Many people use online social networks to obtain information about activities of friends and acquaintances. However, the information obtained by the users from the existing online social networks is limited. Furthermore, the online social networks typically focus on online communication and interaction between the users. The online social networks provide tools for the online communication and online interaction, but have limited functionality for scheduling face to face interactions between the users, specifically for proximate relations. Face to face interactions are still typically scheduled by users over phone calls or text messages. The scheduling requires one to one synchronous communication between the users.

Hence, there is an unmet need for asynchronously scheduling interactions between a first user and one or more second users in an electronic environment based on activity information of the second users.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for asynchronously scheduling interactions between a first user and one or more of multiple second users in an electronic environment based on activity information of the second users. In the computer implemented method and system disclosed herein, the electronic environment may, for example, comprise multiple computing devices, active and passive electronic devices, network devices, networks composed thereof, and users thereof. The second users provide information on multiple activities in the electronic environment. The activity information may comprise type, location, and timing of the activities performed by the second users.

Current activity status and the future activity status of the second users are determined from the activity information. The first user is updated on the determined current activity status and the determined future activity status of the second users. The current activity status and the future activity status of the second users may be automatically updated at predefined points in time. The second users select the predefined time. The second users may be grouped based on one of relationship with the first user, activities performed, and user defined criteria. Activities performed by the second users over a period of time selected by the first user may be displayed to the first user. An activity being performed by one or more second users is designated as active.

An interaction management server in the electronic environment enables the first user to plan the interactions with the second users based on the current activity status and the future activity status of the second users. Planning the interactions may comprise the step of selecting time for the interactions with the second users. The first user may publish information on the planned interactions in the electronic environment for viewing by the second users. The first user may invite the second users to perform an activity. The activity that the second users are invited to may be designated active if the invitation is accepted by at least a predefined number of second users. Context specific advertisements may be provided to the first user. One or more of the activities may be recommended to the first user for planning the interactions. The recommendation is based multiple predefined weighted criteria. Recommending activities to the first user may comprise recommending locations for the activities within a geographical area defined by the first user. The first user may provide current activity status and future activity status in the electronic environment for enabling one or more of the second users to plan an interaction with the first user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of scheduling interactions between a first user and one or more of multiple second users in an electronic environment based on activity information of the second users.

FIG. 2 illustrates a computer implemented system for scheduling interactions between a first user and one or more of multiple second users in an electronic environment based on activity information of the second users.

FIG. 3 exemplarily illustrates an interactive toolbar implemented on a graphical user interface (GUI) summoned using a desktop icon for enabling the first user to view and manage current activity status and future activity status of the first user and the second users.

FIG. 4 exemplarily illustrates a GUI for enabling the second users to provide the activity information.

FIGS. 5A-5F exemplarily illustrate different pictorial representations provided by the toolbar for enabling the user to perform different activity related operations.

FIG. 6 exemplarily illustrates a GUI displaying recommendations of activities to the first user for the interactions.

FIG. 7 exemplarily illustrates a GUI for enabling the first user to assign weights to multiple criteria used for making recommendations to the user.

FIG. 8 exemplarily illustrates an activities webpage for providing a summary of different activities being performed by different second users.

FIG. 9 exemplarily illustrates a GUI for enabling the first user to accept invitations using the activities webpage.

### DETAILED DESCRIPTION OF THE INVENTION

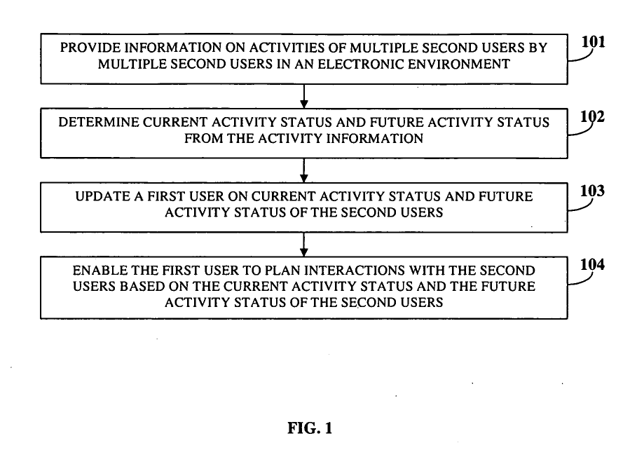

FIG. 1 illustrates a computer implemented method of scheduling interactions between a first user and one or more of multiple second users in an electronic environment based on activity information of the second users. In the computer implemented method and system disclosed herein, the electronic environment may, for example, comprise multiple computing devices, active and passive electronic devices, network devices, networks composed thereof, and users thereof. The computing devices may, for example, be personal computers, mobile phones, personal digital assistants (PDAs), etc. The electronic environment further comprises standard wired or wireless telephone devices capable of voice and data communication and may be extended to other device types and network technologies.

The second users provide 101 information on multiple activities of the second users in the electronic environment. The activity information may comprise type, location, and timing of an activity performed by the first user. For example, the activity information may be “Coffee at Beanery till 9:30 pm”. The second users may provide current activity information or future activity information. For example, each of the second users may provide information at 6 pm about an activity the second user is currently performing and an activity the second user may perform at 10 pm. The second users may also provide information about multiple activities the second users will perform at different points of time in a day. An activity being performed by one or more second users is designated as active.

A current activity status and a future activity status of the second users are determined 102 from the activity information. The current activity status is an indication of activities being currently performed by each of the second users. The first user is updated 103 on the determined current activity status and the determined future activity status of the second users. The first user may select a period of time for which to display the activities performed by the second users. For example, the first user may view current, past, and future activities of the second users within an hour, a day, a week, a month, etc. The first user may be updated on the current activity status and the future activity status only of the second users of who the first user is a “friend”. As used herein, the term “friend” of a user refers to another user connected to the user in the electronic environment by mutual consensus.

The current activity status and the future activity status may be represented graphically. For example, icons may be used to represent different activities performed by the second users. The current activity status and the future activity status may also comprise a route map to or a photograph of the location of the activities of the second users. The current activity status and the future activity status of each of the second users may be automatically updated at predefined points in time. Each of the second users selects the predefined points in time. For example, one of the second users may define status update times as 5 pm, 6 pm, and 8 pm. The second user may also provide activity information for each of the status update times, for example, “coffee at Beanery at 5 pm”, “movie at The Plaza at 6 pm”, and “dinner at Joe's at 8 pm”. The current activity status of the second user is automatically updated to “coffee at Beanery” at 5 pm, then to “movie at The Plaza” at 6 pm, and finally to “dinner at Joe's” at 8 pm. The future activity status is automatically updated to “movie at The Plaza” at 5 pm, and to “dinner at Joe's” at 6 pm. The current activity status of the user changes to reflect the current activity being performed and the future activity status of the second user changes to reflect the next activity to be performed. Hence, at 5 pm, the current activity status is “coffee at Beanery” and the future activity status is “movie at The Plaza”. At 6 pm, the current activity status changes to “movie at The Plaza” and the future activity status changes to “dinner at Joe's”.

An interaction management server in the electronic environment enables 104 the first user to plan the interactions with the second users based on the current activity status and the future activity status of the second users. The first user may be provided multiple online tools for assistance in planning the interactions. The online tools provide the first user different views and options for managing the first user's friends and activities performed by the friends. For further assistance in planning the interactions, the second users may be grouped based on one of relationship with the first user, activities performed, and user defined criteria. For example, if a first set of second users who are colleagues of the first user are performing a first activity and a second set of second users who are members of a club the first user belongs to are performing a second activity, the first set of second users and the second set of second users may be grouped separately and designated as “colleagues” and “club members” respectively.

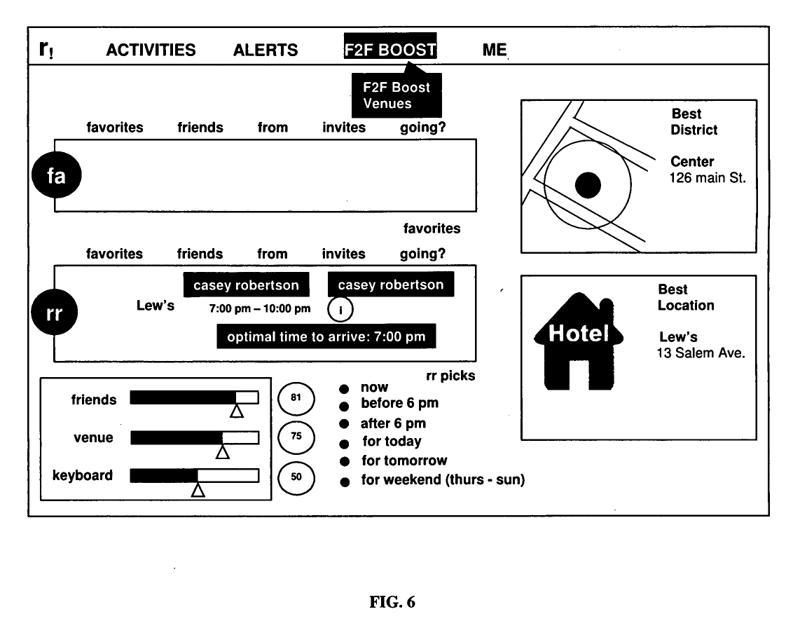

One or more of the activities performed by the second users may be recommended to the first user for the planning the interactions based on multiple predefined weighted criteria. The predefined weighted criteria may comprise number of second users performing the activities, location of the activities, and relationship of the second users performing the activities with the first user. Recommending the activities may, for example, comprise informing the first user about optimal time to arrive at a location for the planned interactions. Recommending activities to the first user may further comprise recommending locations for the activities within a geographical area defined by the first user. For example, if the first user defines a geographical area as “within 1 mile of Point A”, the first user is provided “best” locations within a mile's radius from Point A. The best locations may be determined by number of friends in the locations and closeness of the relationships of those friends to the user. If, for example, two close friends of the first user are at a best location and four close friends of the first user are at four different locations within a geographical area, then the geographical area with the four close friends is recommended as a “best district” to the first user. A GUI displaying recommendations of activities to the first user for the interactions is exemplarily illustrated in FIG. 6.

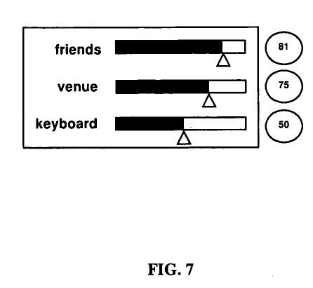

The GUI illustrated in FIG. 6 displays best location for the activity at a given time, number of second users performing the activity, relationships of the second users with first user, and invitations to the activity. The interface also provides arrival and departure times of the second users to the first user. The interface may also provide a text input field for the first user to provide keywords to perform a search. The user may view detailed information on any field in the interface by pointing to the field with a pointing device. A GUI for enabling the first user to assign weights to multiple criteria used for making recommendations to the user is exemplarily illustrated in FIG. 7. Weights of the criteria based on which the recommendations are made are definable by the first user, as exemplarily illustrated in FIG. 7. As illustrated in FIG. 7, the weighted criteria may, for example, be friends, venue, and keywords. The weighted criteria may be assigned any non zero value.

The first user may also assign weights to entities, for example, individual friends, within each of the weighted criteria, for example, “friends”. As an example, the first user may assign weights to each of the first user's friends within the weighted criterion “friends” as illustrated in FIG. 7. The first user may assign weights to the friends based, for example, on closeness of relationship, interests shared, etc. The weights assigned to friends are in turn used to assign a weight to the criterion “friends”.

Context specific advertisements may be provided to the first user. The context specific advertisements may be related to the activities or locations of the activities, or involve historical data gathered from the first user and friends of the first user. For example, if the user is interested in performing a barbecue and grill activity for an interaction, advertisements of different restaurants offering barbecue and grill activities are provided to the user. Alternatively, if the first user is interested in visiting a particular location for the interaction, advertisements about different offers at the location may be provided to the user. The advertisements may, for example, comprise information about discounts, happy hours, etc.

The first user may select time for the interactions with the second users in the electronic environment for viewing by the second users. The first user may publish information on the planned interactions in the electronic environment for viewing by the second users. The published information may, for example, comprise a confirmation of the planned interaction, a user defined message, location of the planned interaction, and activities to be performed for the planned interaction.

The first user may invite multiple second users to perform an activity. The activity the second users are invited to may be designated as active if the invitation is accepted by at least a predefined number of second users. The activity status of the second users who accept the invitation may, for example, change to “Coming to see you”. The first user may also provide current activity status and future activity status in the electronic environment for enabling one or more of the second users to plan interactions with the first user.

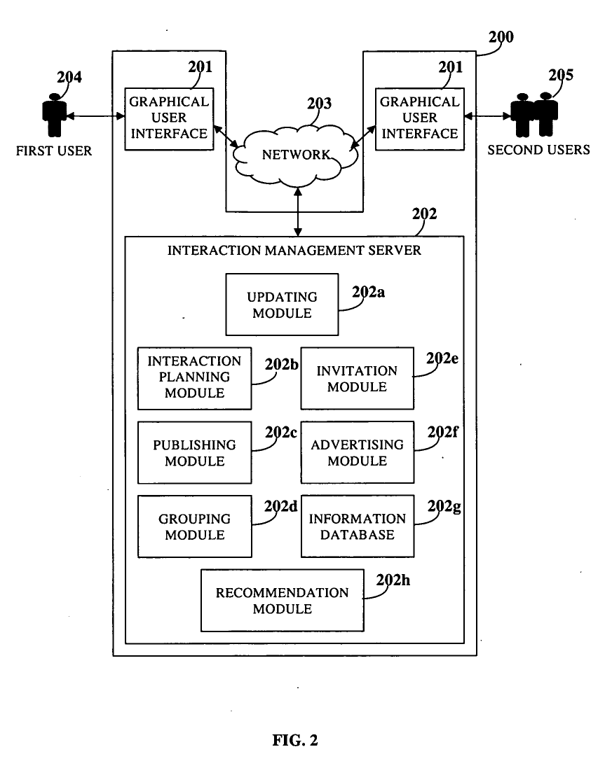

FIG. 2 illustrates a computer implemented system 200 for scheduling interactions between a first user 204 and one or more of multiple second users 205 in an electronic environment based on activity information of the second users 205. The system 200 disclosed herein comprises a graphical user interface (GUI) 201 implemented on a client computing device (not shown) and an interaction management server 202 connected via a network 203. The interaction management server 202 comprises an updating module 202a, an interaction planning module 202b, a publishing module 202c, a grouping module 202d, an invitation module 202e, an advertising module 202f, an information database 202g, and a recommendation module 202h. The computing device may, for example, be a personal computer, a mobile phone, a PDA, etc. A first user 204 and multiple second users 205 communicate with the interaction management server 202 over a network 203 using the GUI 201. The network 203 may, for example, be the internet.

The GUI 201 enables the second users 205 to provide information on multiple activities of the second users 205 in the electronic environment. The updating module 202a updates the first user 204 on current activity status and future activity status of the second users 205. The current activity status and the future activity status are determined from the activity information. An activity being performed by one or more second users 205 is designated as active. The updating module 202a may automatically update the current activity status and the future activity status of the second users 205 at predefined points in time. The predefined time may be selected by the second users 205. The grouping module 202d groups the second users 205 based on one of relationship with the first user 204, activities performed, and user defined criteria.

The GUI 201 may display to the first user 204 activities performed by the second users 205 over a period of time selected by the first user 204. The GUI 201 may also enable the first user 204 to provide current activity status and future activity status in the electronic environment for enabling one or more of the second users 205 to plan an interaction with the first user 204. The interaction planning module 202b enables the first user 204 to plan the interactions with the second users 205 based on the current activity status and the future activity status of the second users 205. The interaction planning module 202b further enables the first user 204 to select time for the interactions with the second users 205. For assistance in selecting the planning the interactions, the GUI 201 provides multiple online tools that provide different views and options for managing the first user's 204 friends and activities performed by the friends.

The recommendation module 202h recommends one or more of the activities to the first user 204 for the planned interactions based on multiple predefined weighted criteria. The recommendation module 202h may recommend locations for the activities within a geographical area, for example, “within 1 mile of Point A”, defined by the first user 204. The invitation module 202e enables the first user 204 to invite multiple second users 205 to perform an activity. The invitation module 202e designates the activity the second users 205 are invited to as active if the invitation is accepted by at least a predefined number of second users 205. The advertising module 202f provides context specific advertisements to the first user 204. The publishing module 202c enables the first user 204 to publish information on the planned interactions in the electronic environment for viewing by the second users 205.

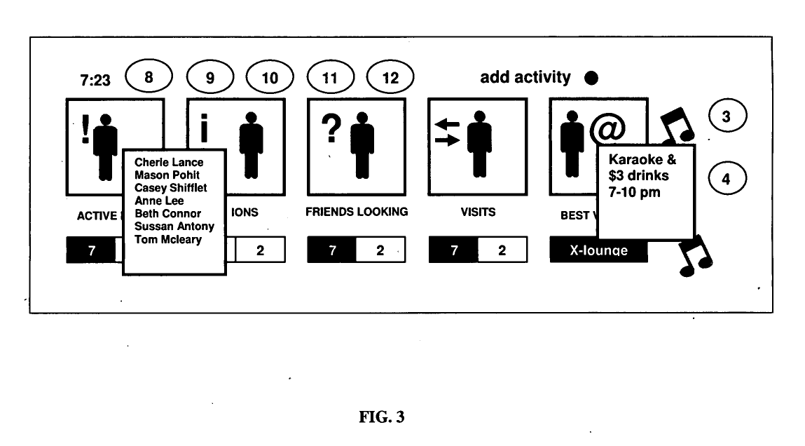

FIG. 3 exemplarily illustrates an interactive toolbar implemented on the GUI 201 summoned using a desktop icon enabling the first user 204 to view and manage activity information of the first user 204 and the second users 205. The toolbar illustrated in FIG. 3 enables the first user 204 to view the activity status of different second users 205. The toolbar may reside on the desktop of a computing device of the first user 204 or be summoned using an icon on the desktop. The toolbar may comprise multiple pictorial representations representing, for example, second users 205 performing an activity, second users 205 looking to perform an activity, second users 205 invited to perform an activity, groups of second users 205, popular locations among the second users 205, popular music at the locations or among the second users 205, etc.

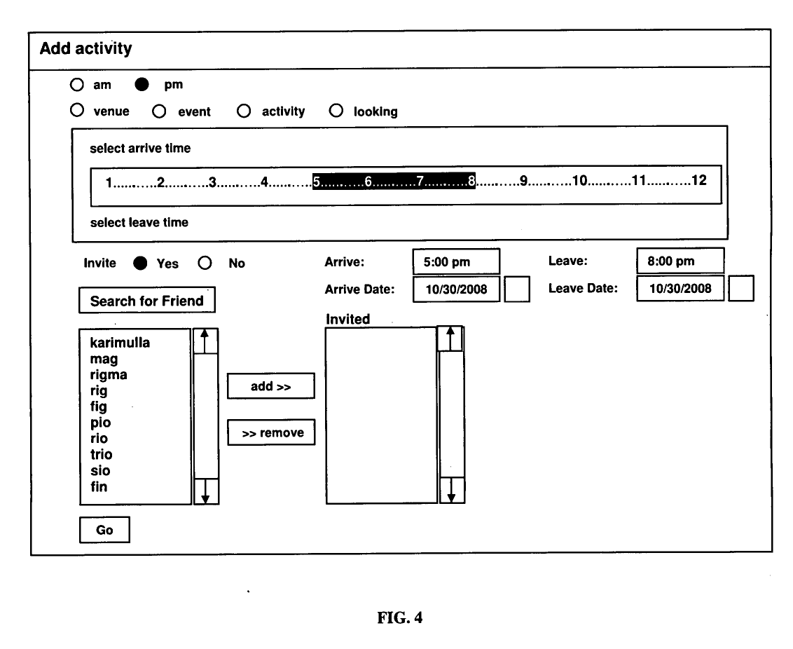

FIG. 4 exemplarily illustrates a GUI 201 for enabling the second users 205 to provide the activity information. The interface may also be used by the first user 204 to provide and edit activity status of the first user 204. The interface may be invoked by selecting one of the pictorial representations illustrated in FIG. 3. The interface enables the second users 205 and the first user 204 to provide time, description, and location of the activity and to invite other users to the activity.

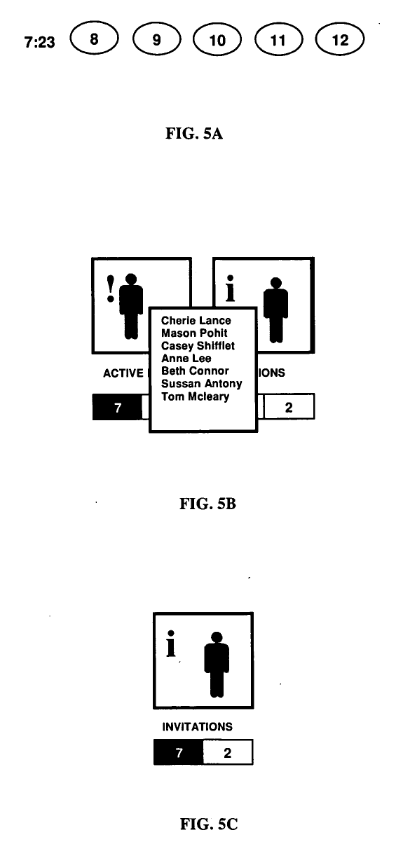

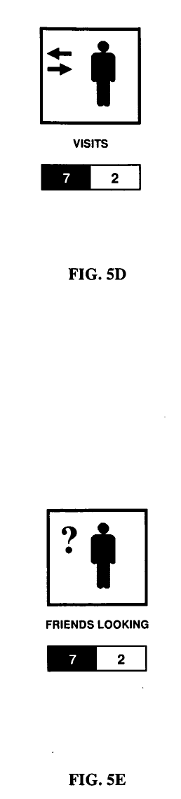

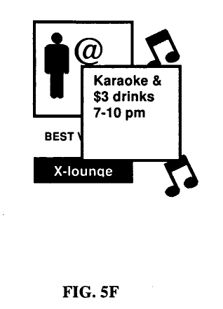

FIGS. 5A-5F exemplarily illustrate different pictorial representations provided by the toolbar for enabling the user to perform different activity related operations. FIG. 5A illustrates a time selection tool for enabling the first user 204 to select a time for receiving the activity status updates on the second users 205. Other information accessible via the toolbar may also be updated at the selected time. FIG. 5B exemplarily illustrates a submenu invoked by clicking on the “!” pictorial representation illustrated in FIG. 3. The submenu provides information on which of the second users 205 are or will be doing an activity in the future. An “i” pictorial representation is used to represent the second users 205 who have invited the first user 204 to join current or future activities. The pictorial representation may also provide information on locations and timings of the activities. In one implementation, the information provided by the submenu may be accessed via a web browser.

FIG. 5C illustrates an “invitations” pictorial representation. An “i” symbol is used to represent invitations from the second users 205. Number of invitations received may be displayed at the bottom of the pictorial representation. In this example, the number “7” illustrates the number of invitations received. The invitations pictorial representations may also be used to accept or reject the invitations. FIG. 5D illustrates a “visits” pictorial representation. The visits pictorial representation displays number of invitations accepted by other users. FIG. 5E illustrates a “friends looking” pictorial representations. A “?” symbol represents second users 205 who either have an activity planned and are looking for other users to join them or second users 205 looking for other users to perform an undefined activity. The pictorial representations provide information on the planned activity, number of users performing the planned activity, and whether or not the planned activity is active. A planned activity becomes active upon at least a predefined number of users performing the planned activity. The predefined number may, for example, be any whole number greater than or equal to 1. If the predefined number is 1, only one user may be performing the activity. FIG. 5F illustrates an “advertisements” pictorial representation. The advertisements pictorial representation provides information on discounts and offers at different locations. The advertisements pictorial representations may also indicate a best location at a given time based on discounts and offers at the locations at the given time.

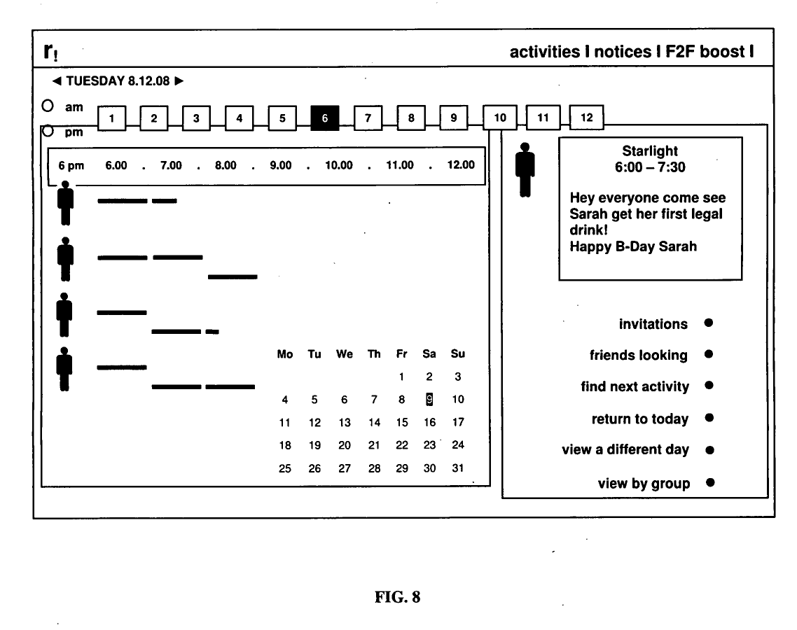

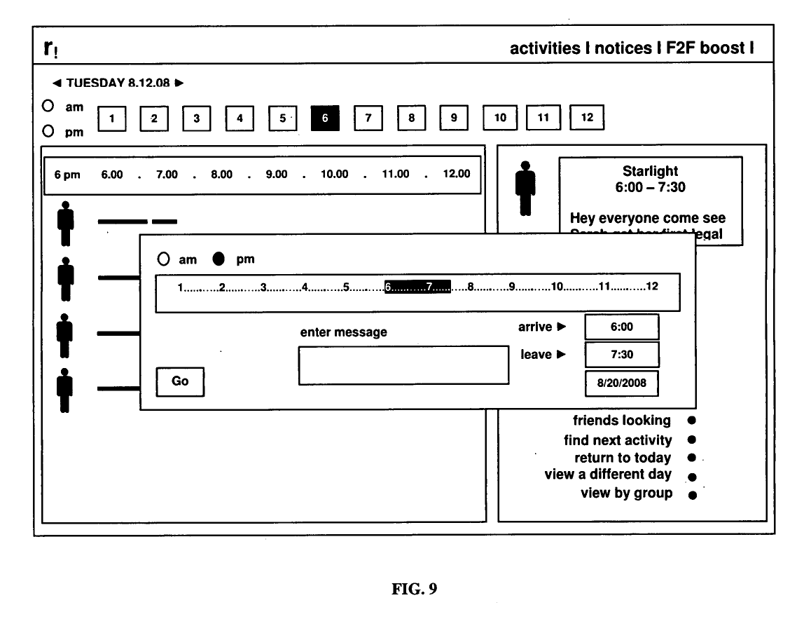

FIG. 8 exemplarily illustrates an “activities” webpage. The activities webpage provides a summary of different activities being performed by different second users 205. The first user 204 may select date and time for which to view the activities. The activities webpage enables the first user 204 to manage friends and invitations, find activities, summon a calendar application, and sort information into user defined groups. The activities webpage also enables the first user 204 to accept invitations received from other users. A GUI 201 for enabling the first user 204 to accept the invitations using the activities webpage is exemplarily illustrated in FIG. 9.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 202g, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of scheduling interactions between a first user and one or more of a plurality of second users in an electronic environment based on activity information of said second users, comprising the steps of:
providing information on a plurality of activities of the second users by the second users in said electronic environment;
updating said first user on current activity status and future activity status of the second users, wherein said current activity status and said future activity status are determined from said activity information; and
enabling the first user to plan said interactions with the second users based on the current activity status and the future activity status of the second users;
whereby said planning enables said scheduling of the interactions with the second users.

2. The computer implemented method of claim 1, wherein the activity information comprises type, location, and timing of said activities performed by the second users.

3. The computer implemented method of claim 1, wherein the planning of the interactions comprises the step of selecting time for the interactions with the second users.

4. The computer implemented method of claim 1, further comprising the step of publishing information on said planned interactions by the first user in the electronic environment for viewing by the second users.

5. The computer implemented method of claim 1, further comprising the step of grouping the second users based on one of relationship with the first user, activities performed, and user defined criteria.

6. The computer implemented method of claim 1, further comprising the step of inviting one or more of the second users by the first user to perform an activity.

7. The computer implemented method of claim 6, further comprising the step of designating said activity as active if said invitation is accepted by at least a predefined number of second users.

8. The computer implemented method of claim 1, further comprising the step of automatically updating the current activity status and the future activity status of the second users at predefined points in time, wherein said predefined points in time is selected by the second users.

9. The computer implemented method of claim 1, further comprising the step of recommending one or more of the activities to the first user for planning the interactions, wherein said recommendation is based on a plurality of predefined weighted criteria.

10. The computer implemented method of claim 9, wherein said step of recommending activities to the first user comprises recommending locations for the activities within a geographical area defined by the first user.

11. The computer implemented method of claim 1, further comprising the step of displaying to the first user activities performed by the second users over a period of time selected by the first user.

12. The computer implemented method of claim 1, further comprising the step of providing current activity status and future activity status by the first user in the electronic environment for enabling one or more of the second users to plan interactions with the first user.

13. A computer implemented system for scheduling interactions between a first user and one or more of a plurality of second users in an electronic environment based on activity information of said second users, comprising:
a graphical user interface for enabling the second users to provide information on a plurality of activities of the second users in said electronic environment;
an interaction management server comprising:
an updating module for updating said first user on current activity status and future activity status of the second users, wherein said updating module determines said current activity status and said future activity status from said activity information; and
an interaction planning module for enabling the first user to plan said interactions with the second users based on the current activity status and the future activity status of the second users.

14. The computer implemented system of claim 13, wherein said interaction planning module enables the first user to select time for the interactions with the second users.

15. The computer implemented system of claim 13, wherein said interaction management server further comprises a publishing module for enabling the first user to publish information on said planned interactions in the electronic environment for viewing by the second users.

16. The computer implemented system of claim 13, wherein said interaction management server further comprises a grouping module for grouping the second users based on one of relationship with the first user, activities performed, and user defined criteria.

17. The computer implemented system of claim 13, wherein said interaction management server further comprises an invitation module for inviting a one or more of the second users by the first user to perform an activity.

18. The computer implemented system of claim 17, wherein said invitation module designates said activity as active if said invitation is accepted by at least a predefined number of second users.

19. The computer implemented system of claim 13, wherein said updating module automatically updates the current activity status and the future activity status of the second users at predefined points in time, wherein said predefined points in time are selected by the second users.

20. The computer implemented system of claim 13, wherein said interaction management server further comprises a recommendation module for recommending one or more of the activities to the first user for the planned interactions based on a plurality of predefined weighted criteria.

21. The computer implemented method of claim 20, wherein said recommendation module recommends locations for the activities within a geographical area defined by the first user.

22. The computer implemented system of claim 13, wherein said graphical user interface displays to the first user activities performed by the second users over a period of time selected by the first user.

23. The computer implemented system of claim 13, wherein the graphical user interface enables the first user to provide current activity status and future activity status in the electronic environment for enabling one or more of the second users to plan an interaction with the first user.

24. The computer implemented system of claim 13, wherein said interaction management server further comprises an information database for storing the activity information, the current activity status, and the future activity status of the first user and the second users.

25. A computer program product comprising computer executable instructions embodied in a computer-readable medium, wherein said computer program product comprises:
a first computer parsable program code for enabling a plurality of second users to provide information on a plurality of activities of said second users in an electronic environment;
a second computer parsable program code for updating a first user on current activity status and future activity status of the second users, wherein said current activity status and said future activity status are determined from said activity information; and
a third computer parsable program code for enabling said first user to plan interactions with the second users based on the current activity status and the future activity status of the second users.
